(19) United States
(12) Patent Application Publication
(10) Pub. No.: US 2015/0346457 A1
(43) Pub. Date: Dec. 3, 2015

(54) MIRROR UNIT

(71) Applicant: GIGAPHOTON INC., Tochigi (JP)

(72) Inventors: Yasufumi KAWASUJI, Tochigi (JP); Hidenobu KAMEDA, Tochigi (JP)

(73) Assignee: GIGAPHOTON INC., Tochigi (JP)

(21) Appl. No.: 14/737,289

(22) Filed: Jun. 11, 2015

Related U.S. Application Data
(63) Continuation of application No. PCT/JP2013/084702, filed on Dec. 25, 2013.

(30) Foreign Application Priority Data
Jan. 31, 2013 (JP) 2013-017446

(51) Int. Cl. G02B 7/182; H05G 2/00; G02B 26/08

(52) U.S. Cl. CPC G02B 7/1827; G02B 26/0816; H05G 2/008

(57) ABSTRACT

A mirror unit may include a mirror, a first holding member holding the mirror, a second holding member holding the first holding member to allow the first holding member to pivot on a first pivot shaft, an actuator provided on the second holding member and configured to allow the first holding member to pivot, and a counter weight provided on the first holding member to allow a centroid of a structure to be substantially coincident with a center of a reflection surface of the mirror. The structure includes the mirror and is pivotable on the first pivot shaft.

### TECHNICAL FIELD

The disclosure relates to a mirror unit.

### BACKGROUND ART

In recent years, miniaturization of transcription pattern of optical lithography in semiconductor process is drastically progressing in association with fining of the semiconductor process. In the next generation, microfabrication of 70 nm to 45 nm, and further microfabrication of 32 nm or less will be required. Therefore, to meet a need of microfabrication of, for example, 32 nm or less, there is expected development of an exposure apparatus that is configured by a combination of a reduction projection reflective optics and an extreme ultraviolet light generation apparatus that generates extreme ultraviolet light with a wavelength of about 13 nm.

As the extreme ultraviolet light generation apparatus, three kinds of apparatuses, a laser produced plasma (LPP) apparatus that uses plasma generated by application of laser light to a target substance, a discharge produced plasma (DPP) apparatus that uses plasma generated by electric discharge, and a synchrotron radiation (SR) apparatus that uses orbital radiated light have been proposed.

### CITATION LIST

### Patent Literature

PTL 1: Japanese Unexamined Patent Application Publication No. H7-20372

PTL 2: Japanese Unexamined Patent Application Publication No. 2011-172331

PTL 3: Japanese Unexamined Patent Application Publication No. 2012-099791

### SUMMARY

A mirror unit may include: a mirror; a first holding member holding the mirror; a second holding member holding the first holding member to allow the first holding member to pivot on a first pivot shaft; an actuator provided on the second holding member and configured to allow the first holding member to pivot; and a counter weight provided on the first holding member to allow a centroid of a structure to be substantially coincident with a center of a reflection surface of the mirror. The structure includes the mirror and is pivotable on the first pivot shaft.

Moreover, a mirror unit may include: a mirror; a first holding member holding the mirror; a second holding member holding the first holding member to allow the first holding member to pivot on a first pivot shaft; a first actuator provided on the second holding member and configured to allow the first holding member to pivot; a third holding member holding the second holding member to allow the second holding member to pivot on a second pivot shaft; a second actuator provided on the third holding member and configured to allow the second holding member to pivot; and a counter weight provided on the first holding member to allow a centroid of a structure to be substantially coincident with a center of a reflection surface of the mirror. The structure includes the mirror and is pivotable on the second pivot shaft.

Moreover, a mirror unit may include: a mirror; a first holding member holding the mirror; a second holding member holding the first holding member to allow the first holding member to pivot on a first pivot shaft; a first actuator provided on the second holding member and configured to allow the first holding member to pivot; a first counter weight provided on the first holding member to allow a centroid of a structure to be substantially coincident with a center of a reflection surface of the mirror, in which the structure includes the mirror and is pivotable on the first pivot shaft; a third holding member holding the second holding member to allow the second holding member to pivot on a second pivot shaft; a second actuator provided on the third holding member and configured to allow the second holding member to pivot; and a second counter weight provided on the second holding member to allow a centroid of a structure to be substantially coincident with the center of the reflection surface of the mirror, in which the structure includes the mirror and is pivotable on the second pivot shaft.

Moreover, a mirror unit may include: a mirror; a first holding member holding the mirror; a second holding member holding the first holding member to allow the first holding member to pivot on a first pivot shaft; a third holding member holding the second holding member to allow the second holding member to pivot on a second pivot shaft; a first actuator provided on the third holding member and configured to allow the first holding member to pivot on the first pivot shaft; a second actuator provided on the third holding member and configured to allow the second holding member to pivot on the second pivot shaft; and a counter weight provided on the first holding member to allow a centroid of a structure to be substantially coincident with a center of a reflection surface of the mirror. The structure includes the mirror and is pivotable on the second pivot shaft.

### BRIEF DESCRIPTION OF DRAWINGS

Some embodiments of the disclosure will be described as examples below with reference to accompanying drawings.

FIG. 1 is a schematic configuration diagram of an illustrative laser produced plasma (LPP) extreme ultra violet (EUV) light generation apparatus according to an embodiment of the disclosure.

FIG. 2 is a schematic configuration diagram of an EUV light generation apparatus including a mirror unit according to an embodiment of the disclosure.

FIG. 3 is an explanatory diagram of a mirror unit provided with a cooling mechanism according to an embodiment of the disclosure.

FIG. 4 is a top view of a mirror unit provided with a counter weight according to a first embodiment of the disclosure.

FIG. 5 is a sectional diagram (1) of the mirror unit provided with the counter weight according to the first embodiment of the disclosure.

FIG. 6 is a sectional diagram (2) of the mirror unit provided with the counter weight according to the first embodiment of the disclosure.

FIG. 7 is a top view of a mirror unit provided with a counter weight according to a second embodiment of the disclosure.

FIG. 8 is a sectional diagram (1) of the mirror unit provided with the counter weight according to the second embodiment of the disclosure.

FIG. 9 is a sectional diagram (2) of the mirror unit provided with the counter weight according to the second embodiment of the disclosure.

FIG. 10 is a top view of a mirror unit provided with a counter weight according to a third embodiment of the disclosure.

FIG. 11 is a sectional diagram (1) of the mirror unit provided with the counter weight according to the third embodiment of the disclosure.

FIG. 12 is a sectional diagram (2) of the mirror unit provided with the counter weight according to the third embodiment of the disclosure.

FIG. 13 is a top view of a mirror unit provided with a counter weight according to a fourth embodiment of the disclosure.

FIG. 14 is a sectional diagram of the mirror unit provided with the counter weight according to the fourth embodiment of the disclosure.

### EMBODIMENTS

### <Contents>

### <1. General Description of EUV Light Generation Apparatus>

### <1.1 Configuration>

### <1.2 Operation>

### <2. EUV Light Generation Apparatus Including Mirror Unit>

### <2.1 Configuration>

### <2.2 Operation>

### <2.3 Problems>

<3. First Embodiment of Mirror Unit Provided with Counter Weight>

### <3.1 Configuration>

### <3.2 Operation>

### <3.3 Action>

<4. Second Embodiment of Mirror Unit Provided with Counter Weight>

### <4.1 Configuration>

### <4.2 Operation>

### <4.3 Action>

<5. Third Embodiment of Mirror Unit Provided with Counter Weight>

### <5.1 Configuration>

### <5.2 Operation>

### <5.3 Action>

<6. Fourth Embodiment of Mirror Unit Provided with Counter Weight>

### <6.1 Configuration>

### <6.2 Operation>

### <6.3 Action>

In the following, some embodiments of the disclosure are described in detail with reference to the drawings. Embodiments described below each illustrates one example of the disclosure and are not intended to limit the contents of the disclosure. Also, all of the configurations and operations described in each embodiment are not necessarily essential for the configurations and operations of the disclosure. Note that like elements are denoted with the same reference numerals, and any redundant description thereof is omitted.

### <1. General Description of EUV Light Generation Apparatus>

### <1.1 Configuration>

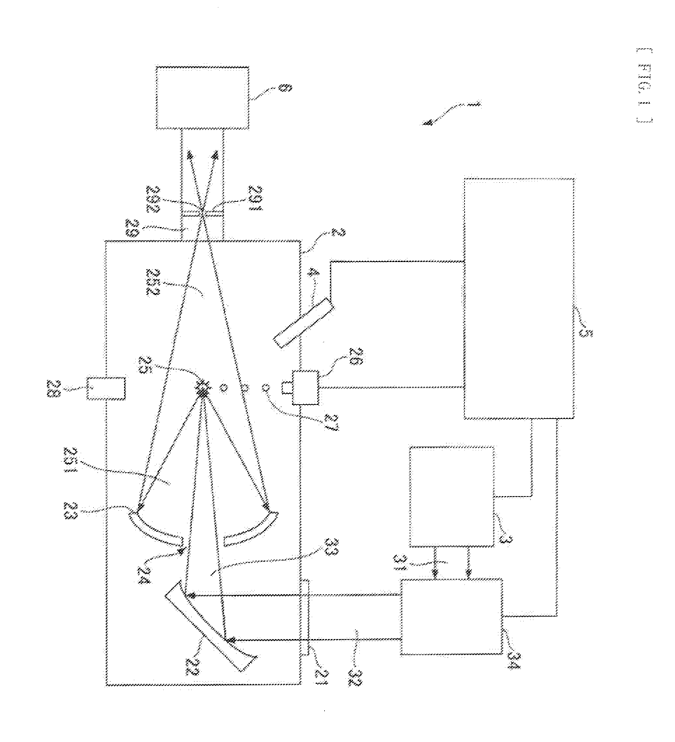

FIG. 1 schematically illustrates a configuration of an illustrative LPP-EUV light generation system. An EUV light generation apparatus 1 may be used together with one or more laser systems 3. In the present application, a system including the EUV light generation apparatus 1 and the laser system 3 is referred to as an EUV light generation system 11. As illustrated in FIG. 1 and as described in detail below, the EUV light generation apparatus 1 may include an EUV chamber 2 and a target generation section 26. The EUV chamber 2 may be hermetically sealable. The target generation section 26 may be so attached as to penetrate through a wall of the EUV chamber 2. A material of a target substance output from the target generation section 26 may include tin, terbium, gadolinium, lithium, xenon, or combination of two or more thereof without limitation.

One or more through holes may be provided on the wall of the EUV chamber 2. A window 21 may be provided at the through hole, and pulsed laser light 32 output from the laser system 3 may pass through the window 21. For example, an EUV condensing mirror 23 including a spheroidal reflection surface may be provided in the inside of the EUV chamber 2. The EUV condensing mirror 23 may include first and second focal points. A multilayer reflection film in which, for example, molybdenum and silicon are alternately stacked may be formed on a surface of the EUV condensing mirror 23. For example, the EUV condensing mirror 23 may be preferably disposed in such a manner that the first focal point is located in a plasma generation region 25 and the second focal point is located at an intermediate focal point (IF) 292. If necessary, a through hole 24 may be provided at a center part of the EUV condensing mirror 23, and the pulsed laser light 33 may pass through the through hole 24.

The EUV light generation apparatus 1 may include an EUV light generation control section 5, a target sensor 4, etc. The target sensor 4 may include an image pickup function and may be adapted to detect presence, trajectory, position, speed, and the like of a target 27.

Moreover, the EUV light generation apparatus 1 may include a connection section 29 that communicates the inside of the EUV chamber 2 with the inside of an exposure apparatus 6. A wall 291 including an aperture may be provided in the inside of the connection section 29. The wall 291 may be provided so that the aperture is located at the second focal point of the EUV condensing mirror 23.

Further, the EUV light generation apparatus 1 may include a laser light traveling direction control section 34, a laser light condensing mirror 22, a target collecting section 28 that is to collect the target 27, and the like. The laser light traveling direction control section 34 may include an optical device adapted to define the traveling direction of the laser light, and an actuator adapted to adjust position, attitude, and the like of the optical device.

### <1.2 Operation>

With reference to FIG. 1, pulsed laser light 31 output from the laser system 3 may pass through the window 21 as pulsed layer light 32 after passing through the laser light traveling direction control section 34 and then, the pulsed laser light 32 may enter the EUV chamber 2. The pulsed laser light 32 may travel in the EUV chamber 2 along one or more laser light paths, and then may be reflected by the laser light condensing mirror 22 to be applied to one or more targets 27 as the pulsed laser light 33.

The target generation section 26 may be adapted to output the target 27 toward the plasma generation region 25 in the EUV chamber 2. One or more pulses included in the pulsed laser light 33 may be applied to the target 27. The target 27 irradiated with the pulsed laser light may be turned into plasma, and radiated light 251 may be radiated from the plasma. The EUV condensing mirror 23 may reflect EUV light included in the radiated light 251 at a higher reflectivity than that of light of other wavelength range. Reflected light 252 that includes the EUV light reflected by the EUV condensing mirror 23 may be condensed at the intermediate focal point 292 and the condensed light may be output to the exposure apparatus 6. Note that a plurality of pulses included in the pulsed laser light 33 may be applied to one target 27.

The EUV light generation control section 5 may be adapted to manage control of the entire EUV light generation system 11. The EUV light generation control section 5 may be adapted to process image data of the target 27 picked up by the target sensor 4, and the like. Moreover, for example, the EUV light generation control section 5 may be adapted to control an output timing of the target 27, an output direction of the target 27, and the like. Further, for example, the EUV light generation control section 5 may be adapted to control an oscillation timing of the laser system 3, the traveling direction of the pulsed laser light 32, a condensing position of the pulsed laser light 33, etc. The above-described various controls are illustrative, and other control may be added as necessary.

### <2. Extreme Ultra Violet Light Generation Apparatus Including Mirror Unit>

### <2.1 Configuration>

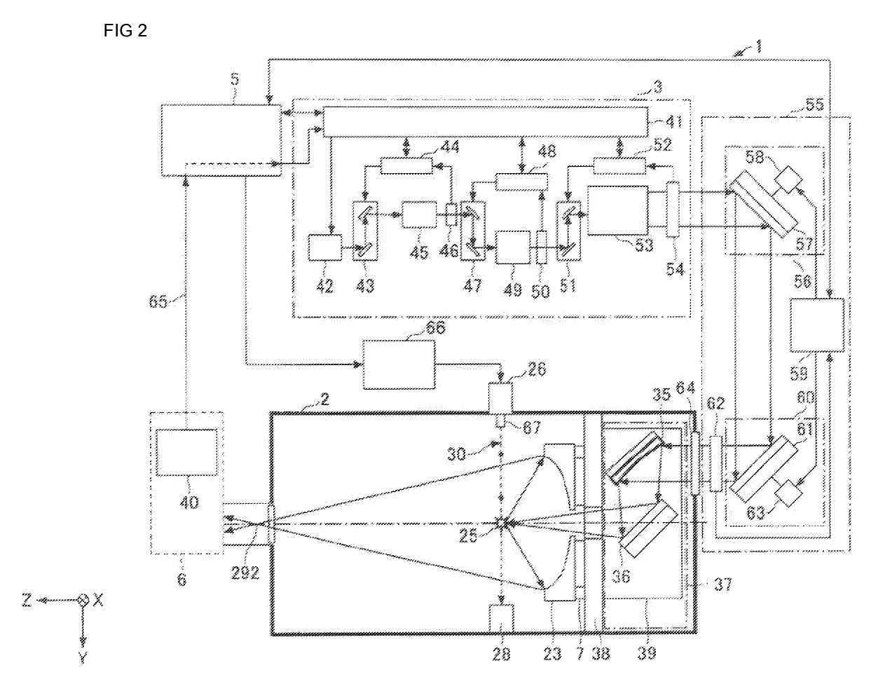

FIG. 2 illustrates a schematic configuration of an EUV light generation apparatus including mirror units 56 and 60 according to an embodiment of the disclosure. Optical path adjusters 43, 47, and 51 each may include two or more reflection optical devices such as mirror units. A laser light condensing optical system 37 may include an off-axis paraboloidal mirror 35, a mirror 36, a plate 38, and a plate 39.

The EUV light generation apparatus 1 may include the laser system 3, a beam supply system 55, the EUV chamber 2, the EUV light generation control section 5, and a target control section 66. Moreover, the EUV light generation apparatus 1 may further include the target generation section 26. For example, the target generation section 26 may be attached to the wall of the EUV chamber 2. The target generation section 26 may include a nozzle 67.

The laser system 3 may include a master oscillator (MO) 42, a power amplifiers (PAs) 45, 49, and 53, the optical path adjusters 43, 47, and 51, sensors 46, 50, and 54, control sections 44, 48, and 52, and a laser apparatus control section 41. The laser apparatus control section 41 may be connected to each of the control sections 44, 48, and 52. The control section 44 may be connected to the optical path adjuster 43 and the sensor 46, the control section 48 may be connected to the optical path adjuster 47 and the sensor 50, and the control section 52 may be connected to the optical path adjuster 51 and the sensor 54. The optical path adjusters 43, 47, and 51 each may include two or more reflection optical devices such as mirror units.

The EUV chamber 2 may include: the laser light condensing optical system 37; the EUV condensing mirror 23; an EUV condensing mirror holder 7 supporting the EUV condensing mirror 23; the target generation section 26; and the target collecting section 28. The laser light condensing optical system 37 may include the off-axis paraboloidal mirror 35, the mirror 36, the plate 38, and the plate 39. The off-axis paraboloidal mirror 35 and the mirror 36 may be supported by the plate 39. The plate 39 may be supported by the plate 38.

The exposure apparatus 6 may include an exposure apparatus control section 40. The EUV light generation control section 5 may be connected to the exposure apparatus control section 40 and the laser apparatus control section 41.

The beam supply system 55 may include the mirror units 56 and 60, a control section 59, and a sensor 62. The mirror unit 56 may include a mirror 57 and an actuator 58 attached to the mirror 57. The mirror unit 60 may include a mirror 61 and an actuator 63 attached to the mirror 61. The control section 59 may be connected to the actuators 58 and 63 and the sensor 62.

Each of the mirrors 57 and 61 may include a flat reflection surface, and the reflection surface may be covered with a high reflection film.

### <2.2 Operation>

The EUV light generation control section 5 may transmit a target output signal to the target control section 66. The exposure apparatus 6 may repeat scan exposure in which EUV light is generated at a predetermined repetition frequency and step movement in which generation of the EUV light is stopped. The exposure apparatus 6 may transmit an oscillation trigger to the laser system 3 through the EUV light generation control section 5. The laser system 3 having received the oscillation trigger may perform burst operation. In the exposure apparatus 6, the scan exposure may be performed by the EUV light generated with use of the laser light that is output from the laser system 3 performing the burst operation.

In the scan exposure, the EUV light generation control section 5 may receive a burst ON signal from the exposure apparatus control section 40 through a connecting wire 65, and then may transmit the oscillation trigger to the laser system 3. The laser apparatus control section 41 of the laser system 3 may receive the burst ON signal from the EUV light generation control section 5 through the connecting wire 65, and then may transmit the oscillation trigger to the MO 42. The MO 42 may perform oscillation in synchronization with the oscillation trigger and may output pulsed laser light. The output pulsed laser light may enter the PA 45 through the optical path adjuster 43, and may pass through an amplification region of the PA 45 to be amplified. The amplified pulsed laser light may then be output. In addition, the traveling direction of the pulsed laser light output from the PA 45 may be detected by the sensor 46.

The control section 44 may transmit a control signal to the two mirror units of the optical path adjuster 43, based on a measurement result derived from the sensor 46. The mirror units may be pivotable, and may change the optical path of the reflected light with use of an unillustrated actuator after receiving the control signal. The actuator may be so controlled as to allow respective mirrors of the two mirror units to pivot by a predetermined angle on two pivot shafts that are parallel to reflection surfaces of the respective mirrors of the two mirror units and are orthogonal to each other on the reflection surfaces, and to stop the respective mirrors. Accordingly, the pulsed laser light subsequently output from the PA 45 may travel along a desired optical path. The pulsed laser light that has passed through the sensor 46 may enter the PA 49 through the optical path adjuster 47, and may pass through an amplification region of the PA 49 to be further amplified. The amplified pulsed laser light may then be output. Moreover, the traveling direction of the pulsed laser light output from the PA 49 may be detected by the sensor 50.

The control section 48 may transmit a control signal to the two mirror units of the optical path adjuster 47, based on a measurement result derived from the sensor 50. The mirror units may be pivotable, and may change the optical path of the reflected light with use of an unillustrated actuator after receiving the control signal. The actuator may be so controlled as to allow respective mirrors of the two mirror units to pivot by a predetermined angle on two pivot shafts that are parallel to reflection surfaces of the respective mirrors of the two mirror units and are orthogonal to each other on the reflection surfaces, and to stop the respective mirrors. Accordingly, the pulsed laser light subsequently output from the PA 49 may travel along a desired optical path.

Likewise, the pulsed laser light that has passed through the sensor 50 may enter the PA 53 through the optical path adjuster 51, and may pass through an amplification region of the PA 53 to be further amplified. The amplified pulsed laser light may then be output. Moreover, the traveling direction of the pulsed laser light output from the PA 53 may be detected by the sensor 54.

The control section 52 may transmit a control signal to the two mirror units of the optical path adjuster 51, based on a measurement result derived from the sensor 54. The mirror units may be pivotable, and may change the optical path of the reflected light with use of an unillustrated actuator after receiving the control signal. The actuator may be so controlled as to allow respective mirrors of the two mirror units to pivot by a predetermined angle on two pivot shafts that are parallel to reflection surfaces of the respective mirrors of the two mirror units and are orthogonal to each other on the reflection surfaces, and to stop the respective mirrors. Accordingly, the pulsed laser light subsequently output from the PA 53 may travel along a desired optical path.

As described above, controlling the optical path by the control sections 44, 48, and 52 may allow the pulsed laser light output from the laser system 3 to stably travel along the desired optical path.

The pulsed laser light output from the laser system 3 may enter the beam supply system 55. The pulsed laser light may enter the sensor 62 after passing through the mirror unit 56 and the mirror unit 60.

The control section 59 may transmit a control signal to the actuator 58 of the mirror unit 56 and the actuator 63 of the mirror unit 60, based on a measurement result derived from the sensor 62. Accordingly, light subsequently entering the window 64 of the EUV chamber 2 may stably travel along the desired optical path. The pulsed laser light that has passed through the sensor 62 may pass through the window 64, and then may be reflected by the off-axis paraboloidal mirror 35 and the mirror 36. The reflected pulsed laser light may be applied to a droplet target that has output from the nozzle 67, has traveled along the trajectory 30, and has reached the plasma generation region 25. As a result, plasma may be generated in the plasma generation region 25 and EUV light may be generated.

In the step movement, the EUV light generation control section 5 may receive a burst OFF signal from the exposure apparatus control section 40 through the connecting wire 65, and then may stop transmission of the oscillation trigger to the laser system 3. As a result, the pulsed laser light is not output from the laser system 3, and the pulsed laser light is not applied to the droplet target that has reached the plasma generation region 25. Therefore, the EUV light may not be generated.

### <2.3 Problems>

In the EUV light generation apparatus 1, output of the laser may reach 20 kW or higher. Therefore, when the surface of the mirror absorbs 0.2% of the output laser, heat up to 40 W may be generated on the mirror surface. Such heat may induce thermal deformation of the mirror surface. To suppress such thermal deformation, a mirror provided with a cooling mechanism including a cooling channel may be used.

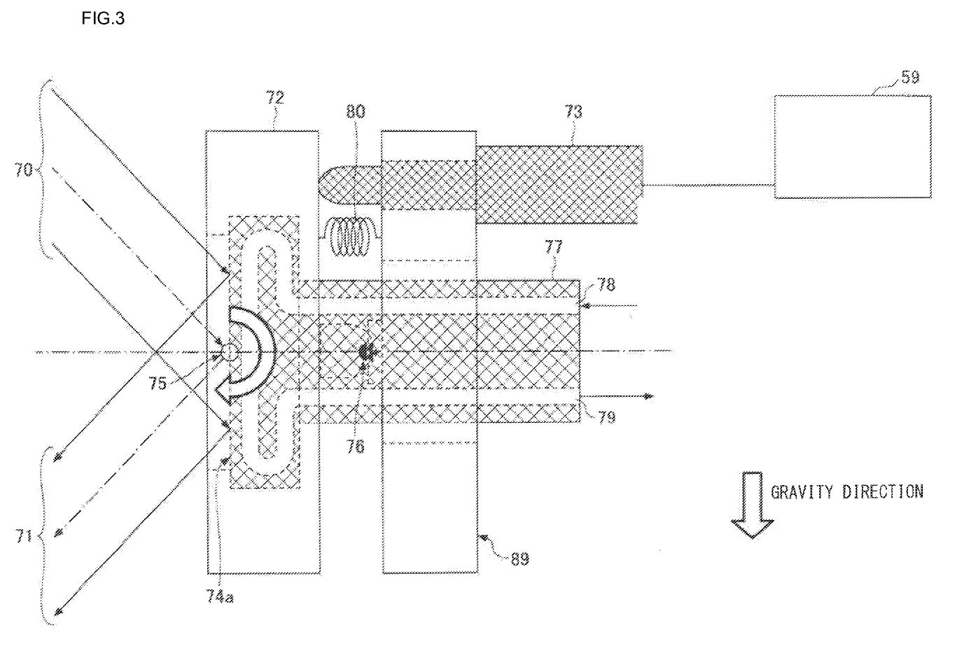

FIG. 3 illustrates a mirror unit provided with a cooling mechanism according to an embodiment of the disclosure. As illustrated in FIG. 3, a mirror 77 provided with a cooling mechanism may be fixed to a mirror holding member 72. A cooling water inlet 78 and a cooling water outlet 79 may be formed in the mirror 77 provided with the cooling mechanism, and a cooling water flow path connecting the cooling water inlet 78 with the cooling water outlet 79 may be formed in the inside of the mirror 77. An immovable region of an actuator 73 may be fixed by a holding member 89 of the actuator. A front end of a movable region of the actuator 73 may be in contact with the mirror holding member 72. In such a configuration, a state may be desirably maintained in which the front end of the actuator 73 and the mirror holding member 72 are constantly in contact with each other at the time when the actuator 73 is driven. Therefore, for example, a spring 80 may be fixed to the mirror holding member 72 and the holding member 89 of the actuator to generate force drawing both members.

Incidentally, in such a mirror unit, a centroid 76 of a pivotable structure in which the mirror 77 is fixed to the mirror holding member 72 may be shifted from a reflection surface 74 of the mirror 77. A pivot shaft 75 of the mirror 77 may be desirably located in the reflection surface 74 of the mirror. In such a case, however, moment of force represented by a product of a distance from a center to the centroid and a total mass of the mirror holding member 72 and the mirror 77 may occur. Therefore, it is necessary for the actuator 73 to generate force pressing the mirror holding member 72 to allow the mirror 77 and the like to pivot, against such moment of force. Note that, in such a mirror unit, entering light 70 entering the mirror 77 may be reflected as a reflected light 71 by the reflection surface 74 of the mirror 77.

Moreover, the configuration of the mirror unit in the optical system in the EUV light generation apparatus 1 may adopt various configurations other than that illustrated in the drawings. The installation position and installation attitude of the mirror may differ depending on the configuration of the optical system. When the distance from the center of the reflection surface to the centroid is large, an actuator and holding structure adapted to the installation position and the installation attitude of the mirror may be desirably designed. However, such design demands costs and efforts in many cases.

For example, when the centroid and the pivot shaft are coincident with each other, the same actuator and the same holding configuration may be used irrespective of the installation position and the installation attitude. Therefore, the mirror unit in which the centroid is coincident with the pivot shaft may be desirably used in the EUV light generation apparatus 1.

<3. First Embodiment of Mirror Unit Provided with Counter Weight>

### <3.1 Configuration>

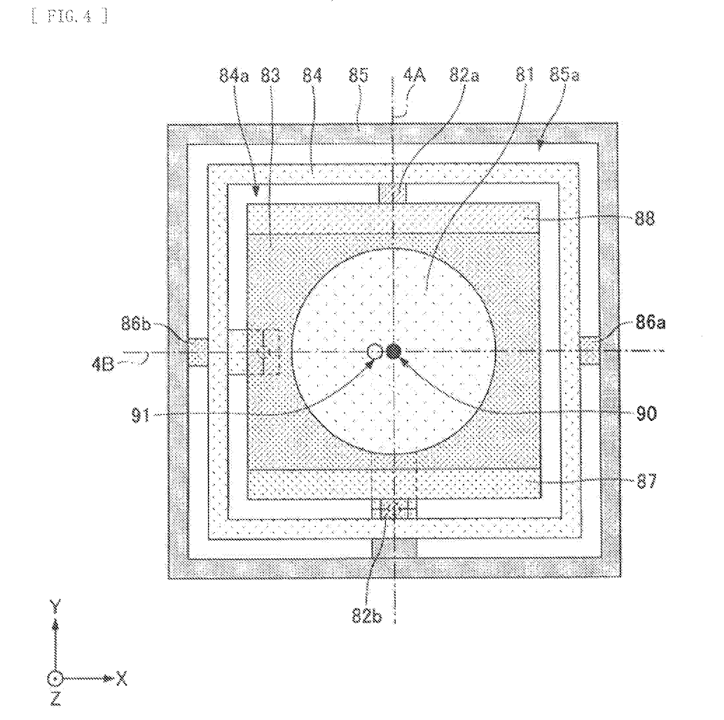

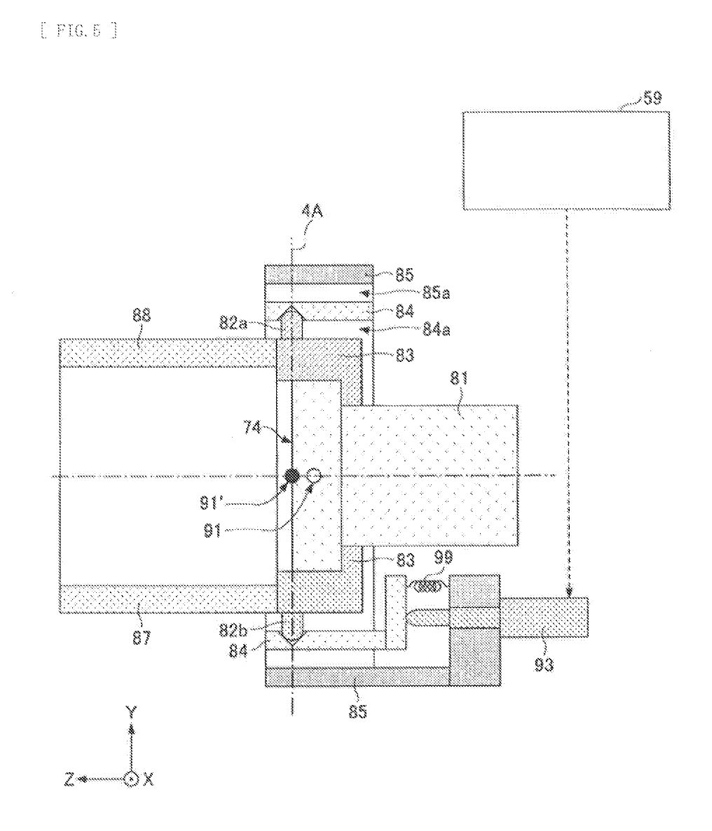

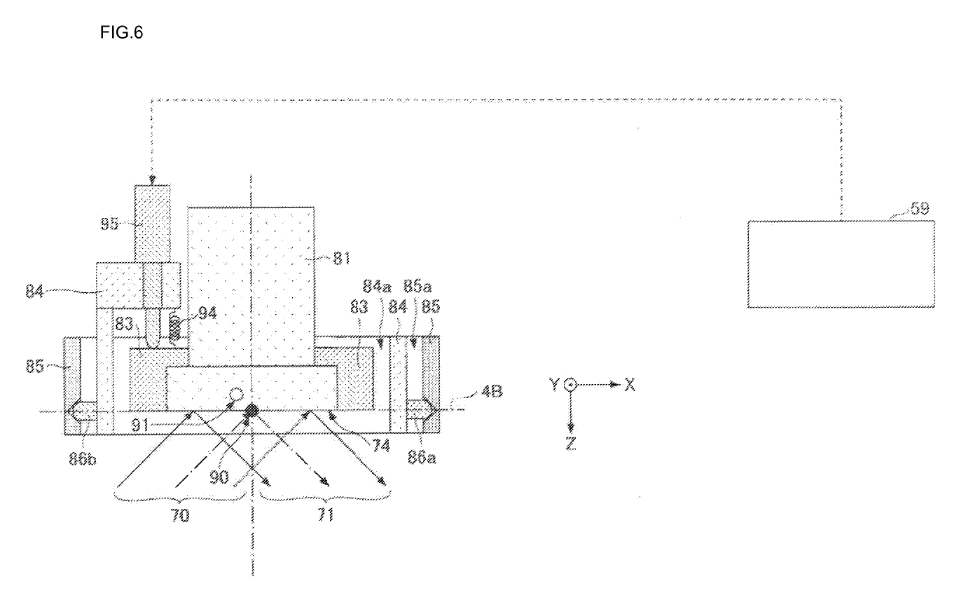

FIG. 4 to FIG. 6 each illustrates a mirror unit provided with a counter weight according to an embodiment of the disclosure. In each of the drawings, a coordinate system is illustrated for easier understanding. Note that FIG. 5 is a sectional diagram of the mirror unit cut along a first axis 4A denoted by an alternate long and short dash line in FIG. 4, and FIG. 6 is a sectional diagram of the mirror unit cut along a second axis 4B denoted by an alternate long and short dash line in FIG. 4.

The mirror unit provided with the counter weight may include a mirror 81, a first holding member 83, a second holding member 84, a third holding member 85, first shafts 82a and 82b, second shafts 86a and 86b, an actuator 95, an actuator 93, a spring 94, a spring 99, a counter weight 87, and a counter weight 88.

A centroid 91′ indicates a centroid of a pivotable structure including the first holding member 83, the counter weight 87, the counter weight 88, and the mirror 81. A centroid 91 indicates a centroid of a pivotable structure including the first holding member 83, the counter weight 87, the counter weight 88, the mirror 81, the second holding member 84, and the actuator 95.

The mirror 81 may be fixed to the first holding member 83. The first shafts 82a and 82b may be fixed to the first holding member 83 to pivot on the first axis 4A that includes the center of the reflection surface 74 of the mirror 81 and is denoted by an alternate long and short dash line parallel to the Y axis.

The counter weight 87 and the counter weight 88 may be fixed to the first holding member 83 in such a manner that the center 90 of the reflection surface 74 of the mirror 81 and the centroid 91 are coincident with each other. In addition, the counter weight 87 and the counter weight 88 may be disposed on the first holding member 83 so as not to shield the entering light 70 and the reflected light 71.

The second holding member 84 may be a ring-shaped member including a through hole that surrounds the first holding member 83 fixed with the mirror 81. Moreover, the second holding member 84 may be provided with bearings receiving the first shafts 82a and 82b of the first holding member 83.

The first holding member 83 may be held by the second holding member 84 through the first shafts 82a and 82b and the bearings corresponding thereto.

The second shafts 86a and 86b may be fixed to the second holding member 84 to pivot on the second axis 4B that includes the center of the reflection surface 74 of the mirror 81 and is denoted by an alternate long and short dash line parallel to the X axis.

The third holding member 85 may be a ring-shaped member including a through hole that surrounds the second holding member 84 fixed with the mirror 81. Moreover, the third holding member 85 may be provided with bearings receiving the second shafts 86a and 86b of the second holding member 84.

The second holding member 84 may be held by the third holding member 85 through the second shafts 86a and 86b and the bearings corresponding thereto.

An immovable region of the actuator 95 may be fixed to the second holding member 84. A front end of a movable region of the actuator 95 may be in contact with the first holding member 83. Therefore, the front end of the actuator 95 may allow the mirror 81 and the first holding member 83 to pivot on the first axis 4A defined by the first shafts 82a and 82b when the actuator 95 is driven.

An immovable region of the actuator 93 may be fixed to the third holding member 85. A front end of a movable region of the actuator 93 may be in contact with the second holding member 84. Therefore, the front end of the actuator 93 may allow the mirror 81, the first holding member 83, and the second holding member 84 to pivot on the second axis 4B that is defined by the second shafts 86a and 86b when the actuator 93 is driven.

The spring 94 may be provided such that an end thereof is fixed to the first holding member 83 and the other end is fixed to the second holding member 84, in the vicinity of a drive section of the actuator 95. The spring 94 may generate force allowing the front end of the actuator 95 to be constantly in contact with the first holding member 83 even when the actuator 95 is driven.

The spring 99 may be provided such that an end thereof is fixed to the second holding member 84 and the other end is fixed to the third holding member 85, in the vicinity of a drive section of the actuator 93. The spring 99 may generate force allowing the front end of the actuator 93 to be constantly in contact with the second holding member 84 even when the actuator 93 is driven.

### <3.2 Operation>

When the drive signal is transmitted from the control section 59 to the actuator 95, the front end of the actuator 95 moves. As a result, the mirror 81 fixed to the first holding member 83 may pivot on the first axis 4A. When the drive signal is transmitted from the control section 59 to the actuator 93, the front end of the actuator 93 moves. As a result, the first holding member 83 fixed to the second holding member 84 may pivot on the second axis 4B.

### <3.3 Action>

Since the actuator 95 is fixed to the second holding member 84, the centroid 91 of the pivotable structure including the first holding member 83 and the mirror 81 gets away from the center 90 of the reflection surface 74 of the mirror 81 by the mass of the actuator 95, as illustrated in FIG. 4.

However, if the mass of the actuator 95 is sufficiently smaller than the mass of the pivotable structure including the first holding member 83, the counter weight 87, the counter weight 88, the mirror 81, and the second holding member 84, the vicinity of the center 90 of the reflection surface 74 of the mirror 81 may be set down as the centroid 91. Moreover, if the mass of the actuator 95 is mass unignorable with respect to the mass of the pivotable structure, the arrangement and the shapes of the counter weight 87 and the counter weight 88 may be adjusted such that the centroid of the pivotable structure including the actuator 95 is coincident with the center 90.

When the counter weight 87 and the counter weight 88 are disposed to the first holding member 83, the center 90 of the reflection surface 74 of the mirror 81 may be close to the centroid 91. As a result, torque around the center 90 may be decreased to an ignorable extent. Accordingly, even if the force driving the actuator 95 and the actuator 93 is small, the actuator 95 and the actuator 93 may allow the mirror 81 to pivot the Y axis (the first axis) and the X axis (the second axis), respectively. Further, responsiveness of the control may become favorable.

<4. Second Embodiment of Mirror Unit Provided with Counter Weight>

### <4.1 Configuration>

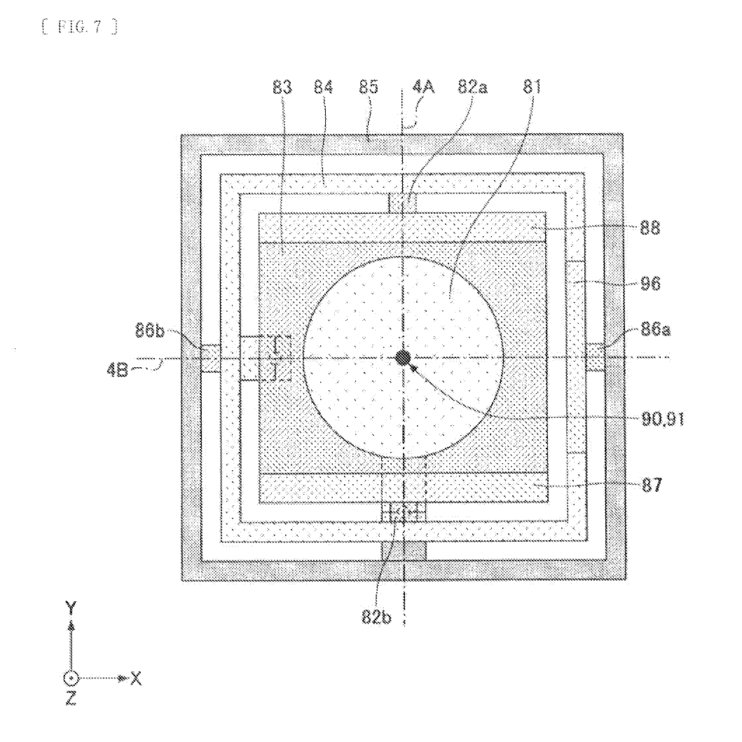

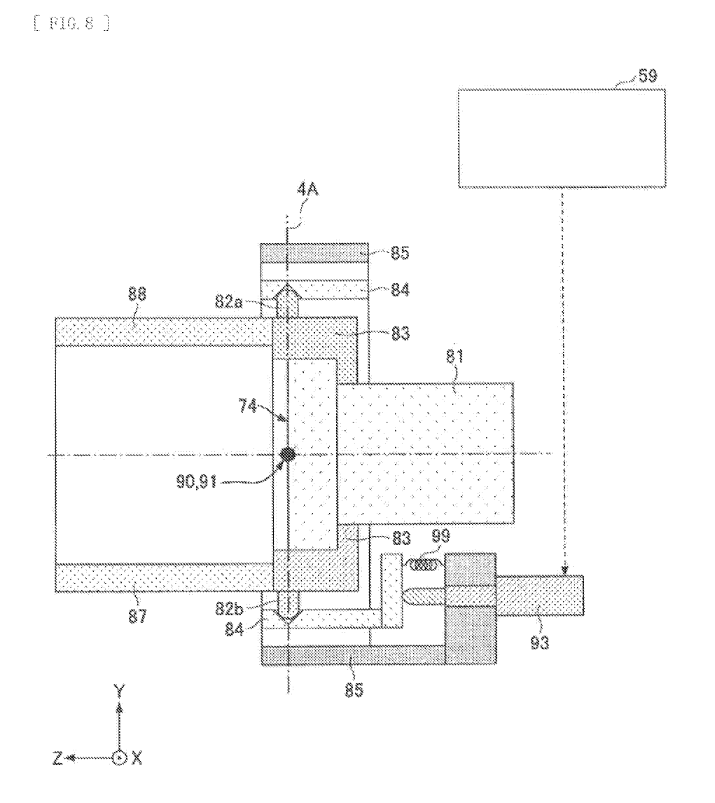

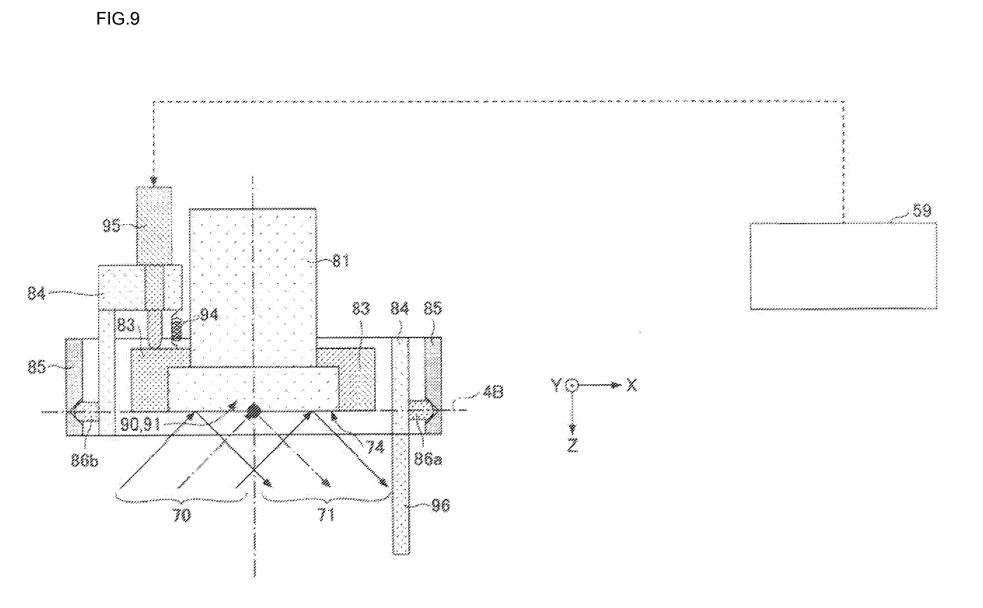

FIG. 7 to FIG. 9 each illustrates a mirror unit provided with a counter weight according to another embodiment of the disclosure. In each drawing, a coordinate system is illustrated for easier understanding. Note that FIG. 8 is a sectional diagram of the mirror unit cut along the first axis 4A denoted by an alternate long and short dash line in FIG. 7, and FIG. 9 is a sectional diagram of the mirror unit cut along the second axis 4B denoted by an alternate long and short dash line in FIG. 7.

The mirror unit illustrated in FIG. 7 to FIG. 9 is substantially the same as the mirror unit illustrated in FIG. 4 to FIG. 6, but is different from the mirror unit illustrated in FIG. 4 to FIG. 6 in that a counter weight 96 is provided in the second holding member 84.

The counter weight 96 may be fixed to the second holding member 84. As a result, the center 90 of the reflection surface 74 may be coincident with the centroid 91 in the pivotable structure including the first holding member 83, the second holding member 84, the actuator 95, the counter weight 96, and the mirror 81. The counter weight 96 at this time may be disposed so as not to shield the entering light 70 entering the mirror 81 and the reflected light 71 reflected by the mirror 81.

In this embodiment, the counter weight 96 is fixed to the second holding member 84, although it is not limited to this embodiment. The counter weight 96 may be fixed to any other member so that the entering light 70 and the reflected light 71 of the mirror 81 are not shielded and the centroid 91 and the center 90 of the reflection surface 74 of the mirror 81 are coincident with each other.

### <4.2 Operation>

When the drive signal is transmitted from the control section 59 to the actuator 95, the front end of the actuator 95 moves. As a result, the mirror 81 fixed to the first holding member 83 may pivot on the first axis 4A. When the drive signal is transmitted from the control section 59 to the actuator 93, the front end of the actuator 93 moves. As a result, the first holding member 83 fixed to the second holding member 84 may pivot on the second axis 4B.

### <4.3 Action>

In the mirror unit illustrated in FIG. 7 to FIG. 9, the counter weight 96 may be fixed to the second holding member 84. Therefore, the center 90 of the reflection surface 74 may be substantially coincident with the centroid 91 in the pivotable structure including the counter weight 87, the counter weight 88, the counter weight 96, the first holding member 83, the second holding member 84, the actuator 95, and the mirror 81. As a result, the torque around the center 90 may be decreased to an ignorable extent.

As a result, as compared with the embodiment illustrated in FIG. 4 to FIG. 6, even if the force driving the actuator 95 and the actuator 93 is small, the actuator 95 and the actuator 93 may allow the mirror 81 to pivot on the first axis 4A and the second axis 4B, respectively. Further, as compared with the embodiment illustrated in FIG. 4 to FIG. 6, responsiveness of the control of the mirror unit may be improved.

<5. Third Embodiment of Mirror Unit Provided with Counter Weight>

### <5.1 Configuration>

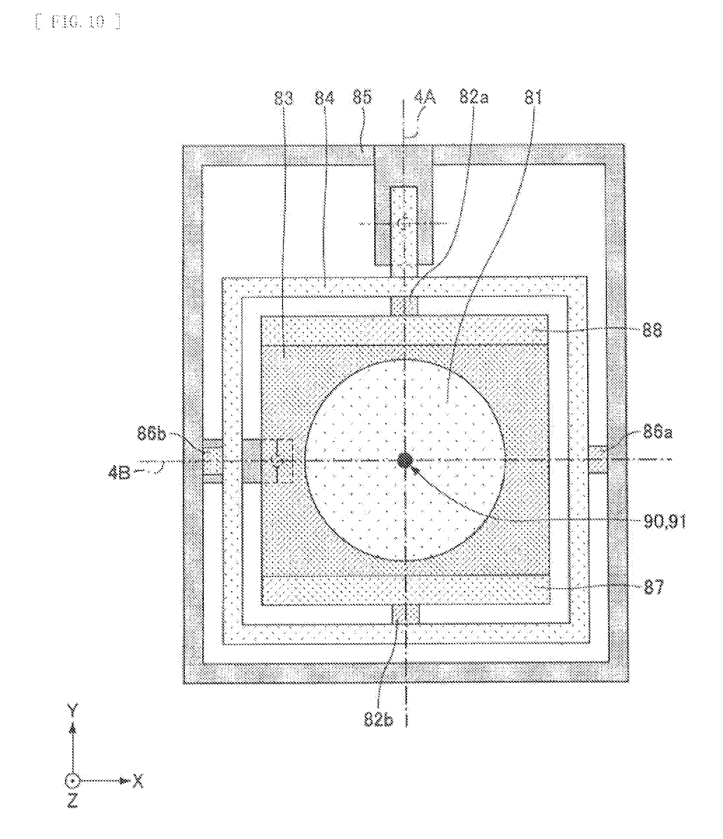

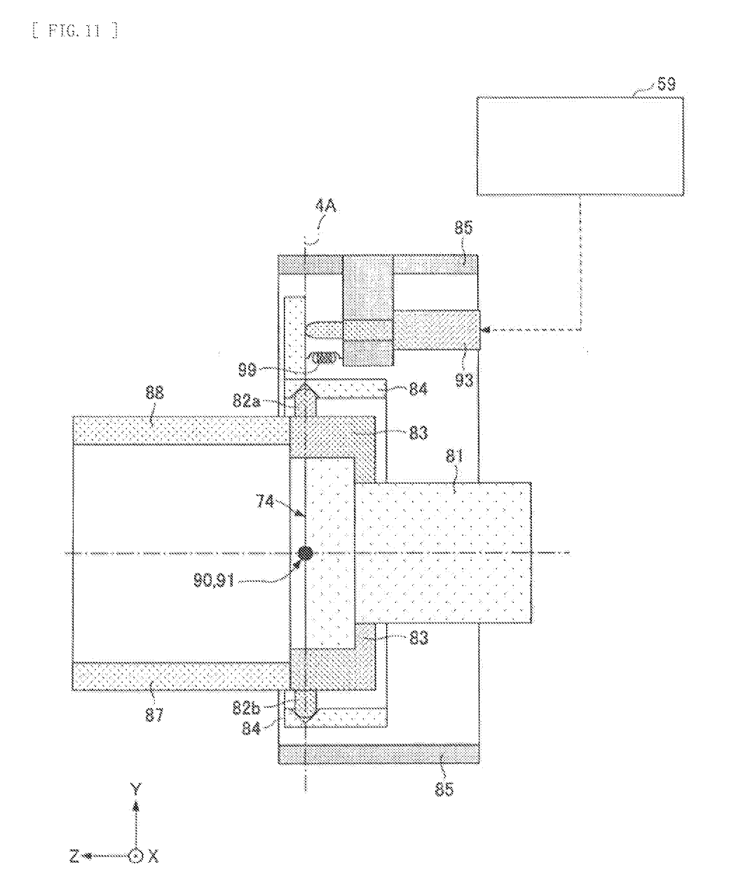

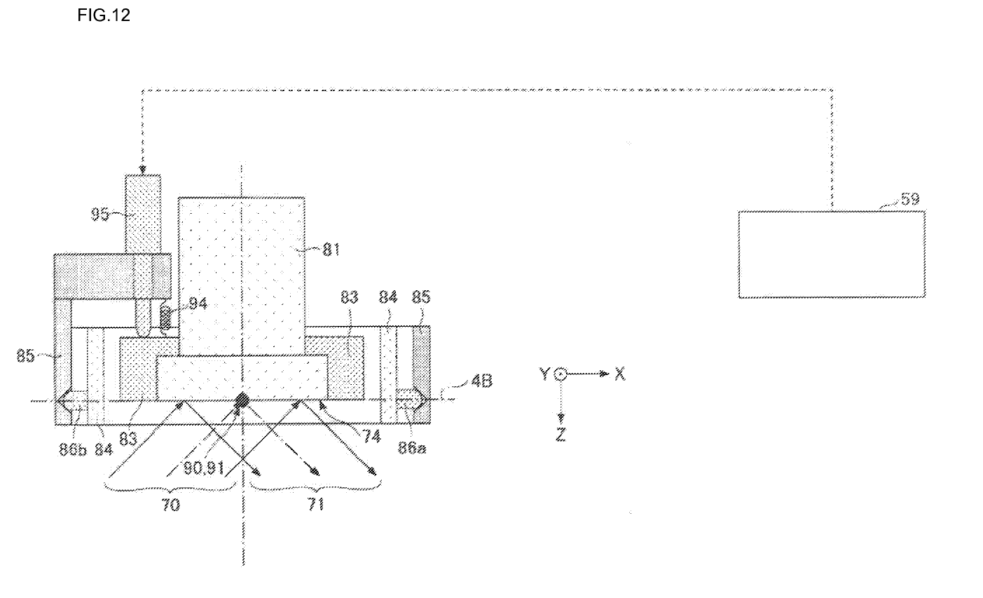

FIG. 10 to FIG. 12 each illustrates a mirror unit provided with a counter weight according to still another embodiment of the disclosure. Note that FIG. 11 is a sectional diagram of the mirror unit cut along the first axis 4A denoted by an alternate long and short dash line in FIG. 10, and FIG. 12 is a sectional diagram of the mirror unit cut along the second axis 4B denoted by an alternate long and short dash line in FIG. 10.

The mirror unit illustrated in FIG. 10 to FIG. 12 is substantially the same as the mirror unit illustrated in FIG. 4 to FIG. 6. However, in the mirror unit illustrated in FIG. 10 to FIG. 12, the actuator 93 and the actuator 95 may be fixed to the third holding member 85, and the spring 94 may be fixed to the first holding member 83 and the third holding member 85. Further, the front end of the actuator 93 may be in contact with the second holding member 84 in the vicinity of the first axis 4A. Desirably, the front end of the actuator 93 may be in contact with the second holding member 84 in a plane including the first axis 4A and a symmetrical axis in a case where the mirror 81 is axially symmetric. Likewise, the front end of the actuator 95 may be in contact with the first holding member 83 in a plane including the second axis 4B and a symmetrical axis in the case where the mirror 81 is axially symmetric.

### <5.2 Operation>

When the drive signal is transmitted from the control section 59 to the actuator 95, the front end of the actuator 95 moves. As a result, the mirror 81 fixed to the first holding member 83 may pivot on the first axis 4A denoted by an alternate long and short dash line in the first shafts 82a and 82b. When the drive signal is transmitted from the control section 59 to the actuator 93, the front end of the actuator 93 moves. As a result, the first holding member 83 held by the second holding member 84 may pivot on the second axis 4B denoted by an alternate long and short dash line in the second shafts 86a and 86b.

Driving the actuator 95 may allow the first holding member 83 to pivot on the first axis 4A. Driving the actuator 93 may allow the second holding member 84 to pivot on the second axis 4B.

### <5.3 Action>

Since the actuator 93 and the actuator 95 are both fixed to the third holding member 85, the center 90 of the reflection surface 74 of the mirror 81 and the centroid 91 may be substantially coincident with each other. As a result, the torque around the center 90 may be decreased to an ignorable extent.

As a result, as compared with the embodiment illustrated in FIG. 4 to FIG. 6, even if the force driving the actuator 95 and the actuator 93 is small, the actuator 95 and the actuator 93 may allow the mirror 81 to pivot on the first axis 4A and the second axis 4B, respectively. Further, as compared with the embodiment illustrated in FIG. 4 to FIG. 6, responsiveness of the control may be improved.

Since the actuator 93 and the actuator 95 may be fixed to the third holding member 85, the mass of the pivoting part may be reduced. As a result, responsiveness of the control of the mirror unit may be further improved.

<6. Fourth Embodiment of Mirror Unit Provided with Counter Weight>

### <6.1 Configuration>

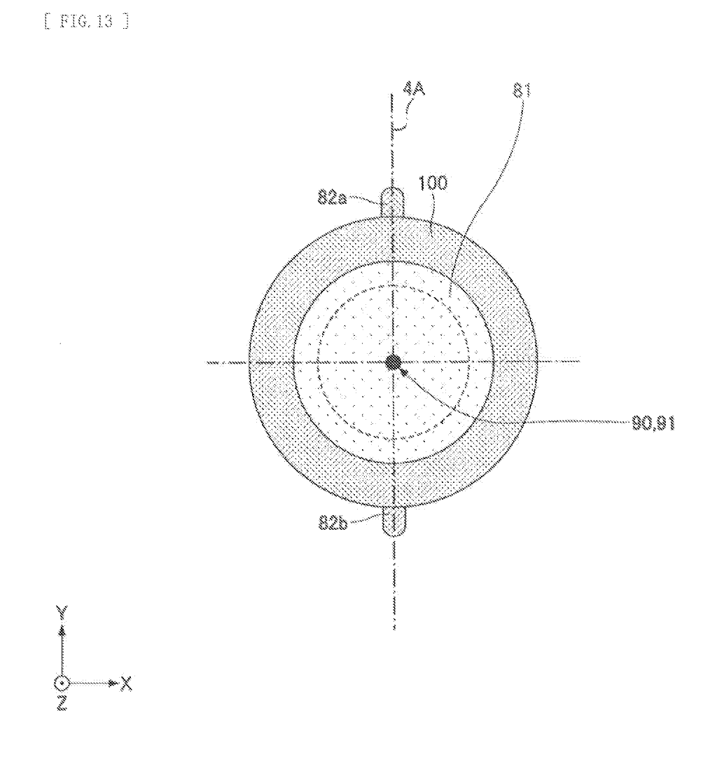

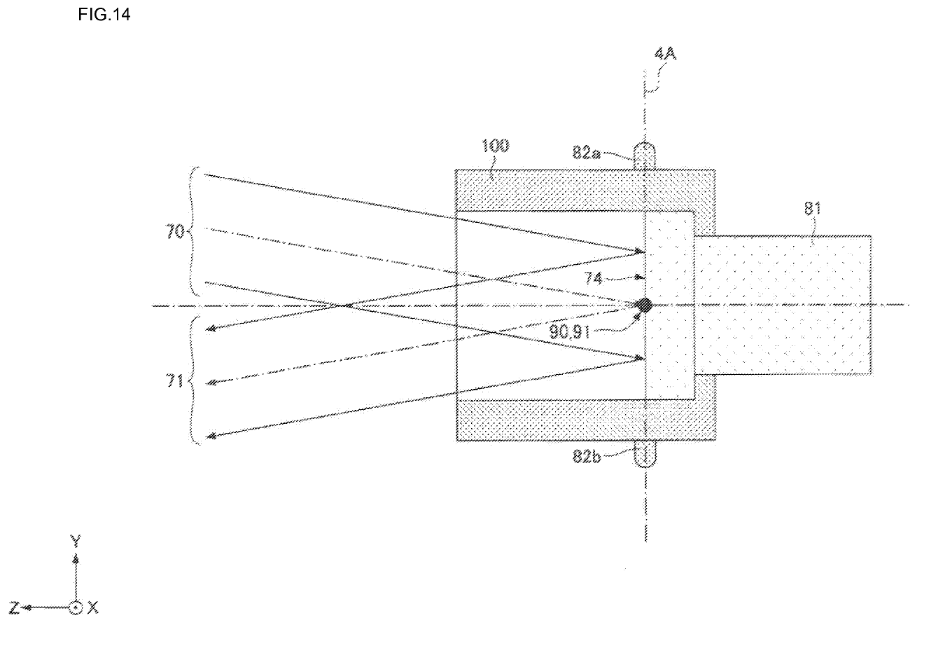

FIG. 13 and FIG. 14 each illustrates a mirror unit provided with a counter weight according to still another embodiment of the disclosure. Note that FIG. 14 is a sectional diagram of the mirror unit cut along the first axis 4A denoted by an alternate long and short dash line in FIG. 13.

A first holding member 100 functioning as the counter weight illustrated in FIG. 13 and FIG. 14 may be applied to the mirror unit illustrated in FIG. 4 to FIG. 6, the mirror unit illustrated in FIG. 10 to FIG. 12, and the like.

The first holding member 83 and the counter weight may be configured as an integral member. A part of the first holding member 100 on a light receiving side may be formed in a tubular shape not shielding the entering light 70 and the reflected light 71.

### <6.2 Operation>

Similarly to the case of <3.2 Operation> and <5.2 Operation>, when the drive signal is transmitted from the control section 59 to the actuator 95, the front end of the actuator 95 moves. As a result, the mirror 81 fixed to the first holding member 100 functioning as the counter weight may pivot on the first axis 4A in the first shafts 82a and 82b. When the drive signal is transmitted from the control section 59 to the actuator 93, the front end of the actuator 93 moves. As a result, the first holding member 100 functioning as the counter weight held by the second holding member 84 may pivot on the second axis 4B in the second shafts 86a and 86b.

### <6.3 Action>

Since the first holding member 100 holding the mirror 81 functions as the counter weight, reduction of the costs may be expected with simple configuration. Other actions may be equivalent to those of the mirror unit illustrated in FIG. 4 to FIG. 6 or the mirror unit illustrated in FIG. 10 to FIG. 12.

Incidentally, in the above description, the cases where the first to fourth embodiments are applied to the mirror units 56 and 60 have been exemplified, although they are not limited thereto. For example, the embodiments of the disclosure may be applied to one of the mirror units of the optical path adjusters 43, 47, and 51 in FIG. 2 and the mirror unit of the laser light condensing optical system 37.

The foregoing description is intended to be merely illustrative rather than limiting. It should therefore be appreciated that variations may be made in embodiments of the disclosure by persons skilled in the art without departing from the scope as defined by the appended claims.

The terms used throughout the specification and the appended claims are to be construed as “open-ended” terms. For example, the term “includes/include/including” or “included” is to be construed as “including but not limited to”. The term “has/have/having” is to be construed as “having but not limited to”. Also, the indefinite article “a/an” described in the specification and recited in the appended claims is to be construed to mean “at least one” or “one or more”.

This application claims the benefit of priority of the Japanese Patent Application No. 2013-017446 filed on Jan. 31, 2013, the entire contents of which are incorporated herein by reference.

### REFERENCE SIGNS LIST

1 EUV light generation apparatus
2 EUV chamber
3 Laser system
4 Target sensor
5 EUV light generation control section
6 Exposure apparatus
7 EUV light condensing mirror holder
21 Window
22 Laser light condensing mirror
23 EUV light condensing mirror
24 Through hole
25 Plasma generation region
26 Target generation section
27 Target
28 Target collecting section
29 Connection section
30 Trajectory of droplet target
31 Pulsed laser light
32 Pulsed laser light
33 Pulsed laser light
34 Laser light traveling direction control actuator
35 Off-axis paraboloidal mirror
36 Mirror
37 Laser light condensing optical system
38 Plate
39 Plate
40 Exposure apparatus control section
41 Laser apparatus control section
42 Master oscillator (MO)
43 Optical path adjuster
44 Control section
45 Power amplifier (PA)
46 Sensor
47 Optical path adjuster
48 Control section
49 Power amplifier (PA)
50 Sensor
51 Optical path adjuster
52 Control section
53 Power amplifier (PA)
54 Sensor
55 Beam supply system
56 Mirror unit
57 Mirror
58 Actuator
59 Control section
60 Mirror unit
61 Mirror
62 Sensor
63 Actuator
64 Window
65 Connecting wire
66 Target control section
67 Nozzle
70 Entering light
71 Reflected light
72 Mirror holding member
73 Automatic actuator
74 Reflection surface of mirror
75 Pivot shaft
76 Centroid of pivotable structure including mirror holding member and mirror
77 Mirror provided with cooling mechanism
78 Cooling water inlet
79 Cooling water outlet
80 Spring
81 Mirror
82 First shaft
83 First holding member
84 Second holding member
85 Third holding member
86 Second shaft
87 Counter weight
88 Counter weight
89 Holding member of actuator
90 Center
91′ Centroid of pivotable structure including first holding member, counter weight, and mirror
91 Centroid of pivotable structure including first holding member, counter weight, second holding member, actuator fixed to second holding member, and mirror
93 Actuator
94 Spring
95 Actuator
96 Counter weight
97 Second holding member
98 Third holding member
99 Spring
100 First holding member provided with function of counter weight
251 Radiated light
252 Reflected light
291 Wall
292 Intermediate focal point (IF)

1. A mirror unit comprising:
a mirror;
a first holding member holding the mirror;
a second holding member holding the first holding member to allow the first holding member to pivot on a first pivot shaft;
an actuator provided on the second holding member and configured to allow the first holding member to pivot; and
a counter weight provided on the first holding member to allow a centroid of a structure to be substantially coincident with a center of a reflection surface of the mirror, the structure including the mirror and being pivotable on the first pivot shaft.

2. A mirror unit comprising:
a mirror;
a first holding member holding the mirror;
a second holding member holding the first holding member to allow the first holding member to pivot on a first pivot shaft;
a first actuator provided on the second holding member and configured to allow the first holding member to pivot;
a third holding member holding the second holding member to allow the second holding member to pivot on a second pivot shaft;
a second actuator provided on the third holding member and configured to allow the second holding member to pivot; and
a counter weight provided on the first holding member to allow a centroid of a structure to be substantially coincident with a center of a reflection surface of the mirror, the structure including the mirror and being pivotable on the second pivot shaft.

3. A mirror unit comprising:
a mirror;
a first holding member holding the mirror;
a second holding member holding the first holding member to allow the first holding member to pivot on a first pivot shaft;
a first actuator provided on the second holding member and configured to allow the first holding member to pivot;
a first counter weight provided on the first holding member to allow a centroid of a structure to be substantially coincident with a center of a reflection surface of the mirror, the structure including the mirror and being pivotable on the first pivot shaft;
a third holding member holding the second holding member to allow the second holding member to pivot on a second pivot shaft;
a second actuator provided on the third holding member and configured to allow the second holding member to pivot; and
a second counter weight provided on the second holding member to allow a centroid of a structure to be substantially coincident with the center of the reflection surface of the mirror, the structure including the mirror and being pivotable on the second pivot shaft.

4. A mirror unit comprising:
a mirror;
a first holding member holding the mirror;
a second holding member holding the first holding member to allow the first holding member to pivot on a first pivot shaft;
a third holding member holding the second holding member to allow the second holding member to pivot on a second pivot shaft;
a first actuator provided on the third holding member and configured to allow the first holding member to pivot on the first pivot shaft;
a second actuator provided on the third holding member and configured to allow the second holding member to pivot on the second pivot shaft; and
a counter weight provided on the first holding member to allow a centroid of a structure to be substantially coincident with a center of a reflection surface of the mirror, the structure including the mirror and being pivotable on the second pivot shaft.

5. The mirror unit according to claim 2, wherein the counter weight and the first holding member are configured as an integral member.

6. The mirror unit according to claim 4, wherein the counter weight and the first holding member are configured as an integral member.

7. The mirror unit according to claim 2, wherein the second holding member and the third holding member are configured to allow the first pivot shaft to be orthogonal to the second pivot shaft.

8. The mirror unit according to claim 4, wherein the second holding member and the third holding member are configured to allow the first pivot shaft to be orthogonal to the second pivot shaft.
